(19) United States
(12) Patent Application Publication
(10) Pub. No.: US 2004/0204864 A1
(43) Pub. Date: Oct. 14, 2004

(54) Signal to noise ratio in chromatography

(76) Inventor: Robert W. Allington, Lincoln, NE (US)

Correspondence Address: STURM & FIX LLP, 206 SIXTH AVENUE, SUITE 1213, DES MOINES, IA, 50309-4076, US

(21) Appl. No.: 10/410,373

(22) Filed: Apr. 9, 2003

(51) Int. Cl. G01N 30/02

(52) U.S. Cl. 702/25

(57) ABSTRACT

Signals obtained in High Performance Liquid Chromatography (HPLC) are notoriously noisy. The signal can be improved by increasing the path length of the light passing through the sample, but increased path length also invites greater refraction and reflection of that light. A novel approach is to utilize a number of photocell sensors lined up along a capillary through which the solution passes. Through careful measurement and calculation, a signal for a single fluid particle can be produced by all the photocell sensors. By incorporating an appropriate delay between each signal, to take into account the finite speed of the fluid, the resulting plurality of noisy signals can be summed or statistically correlated. The signal, containing the important information about the fluid, will increase with the number of photocells used, while the noise increases by the square root of the number of photocells used. The signal to noise ratio, then, increases as the square of the number of photocells used. In this way, the effective path length is increased without including any moving parts.

### BACKGROUND OF THE INVENTION

1. Field of the Invention

The present invention relates generally to a method and apparatus for increasing the signal to noise ratio of a signal received from a photocell used in capillary High Performance Liquid Chromatography (HPLC). In capillary HPLC a capillary tube serves as the chromatographic column. If the capillary is an open tube, its inside diameter may be from 10 μm (detector sensitivity) to 100 μm (detector volume). Packed capillary columns have analogous volume limits. More particularly the present invention makes use of a plurality of photocells all receiving light through the same particle of fluid. The signals created by all the photocells are summed. They contain the same information about the fluid, but different noise.

2. Background Art

To identify components and their concentration in a mixture of solute and solvent, light is passed through the solution. The light that is neither reflected nor absorbed impinges on a photocell, where the intensity of the light is converted to an electrical signal. The intensity of the light hitting the photocell is related to the concentration of a particular solute in the solution. Sensitivity of this system is proportional to the path length of the light as it passes through the sample. Recall that the flow of the solution is through a capillary tube. Increasing the path length in the “usual fashion,” however, invites problems related to widening and “blurring” of peaks because of Poiseulle flow distribution along the light path.

Sources of noise in the signal include the light source, thermal effects, and turbulence in the flow of the solution. The signal to noise ratio of the signal produced by a single, stationary photocell may be too low to be useful. It becomes difficult or impossible to pick out peaks of the signal in the signal because the signal is extraordinarily low and the noise level is as high as in a larger diameter (e.g. 4.7 mm i.d.) chromatographic flow system. A signal to noise ratio of about 2 is considered the lowest acceptable. To overcome this difficulty, it is possible to move the light source and photocell along a capillary tube through which the solute is flowing; or to move the capillary tube past the light source and sensor. The relative velocity at which the capillary tube moves compared to the light source and photocell is equal to the maximum velocity (in any infinitesimally thin slice of fluid in cross-section) of the fluid. The purpose being to generate a “signature” of a particular particle of fluid moving at the centerline speed of the flow. This approach has its weaknesses, including the need for accurately correlating the relative positions of the detector and capillary tube with the peaks observed. The need for moving parts increases the complexity of the apparatus and the potential for failure.

R. E. McKean, in his University of Massachusetts Ph.D. dissertation “Improving the Signal-to-Noise Ratio by Cross Correlation in Flow Injection Analysis and High Performance Liquid Chromatography” (1990) revealed a method for reducing the signal to noise ratio in high performance liquid chromatography. His approach was to produce a clean (relatively noise free) signal in an artificial setting with high concentrations of the solutes. This clean signal was then cross correlated with the noisy signals produced in the usual settings. Although this approach was successful, it brings up the question of how to produce a clean signal when the solutes are unknown. Also, McKean used chromatography equipment of the late 1980's.

McKean discusses the ensemble averaging of multiple signals to improve the signal to noise ratio. He does not, however, suggest the use of multiple sensors and indicates the averaging approach would be “time consuming” for high performance liquid chromatography, presumably due to needing to run multiple identical samples past a single sensor. McKean, because his research focused on his cross correlation method, did not have motivation to utilize multiple sensors for summing or averaging signals in a complete chromatogram.

Another novel approach was suggested by Hjerten in U.S. Pat. No. 5,114,551 in which a single detector was used to pick up a signal at multiple locations on the capillary. This was done by looping the capillary around and returning back to the light source and sensor location. A relatively small improvement in the signal to noise ratio would be realized with this method due to the limited number of chromatograms that can feasibly be taken. In one embodiment of this invention, the capillary tube is moved laterally in order to move a new portion of the capillary tube between the light source and sensor. This is an unnecessary complication, requiring control circuitry and moving parts that can fail. The flow, too, is not favorably enhanced by looping or by moving the capillary tube.

There is, therefore, a need for a way to significantly improve the signal to noise ratio of the signal produced by photocells in capillary high-pressure liquid chromatography with no moving parts.

### SUMMARY OF THE INVENTION

A purpose of this invention is to provide a method and device capable of producing a substantially clean signal in high-pressure liquid chromatography. Another purpose of the present invention is to carry out the aforementioned purpose with no moving parts.

It is well known that the sensitivity of a chromatograph is directly proportional to the path length of a beam of light passing through the sample. An indirect method of increasing this path length is to repeatedly take a chromatograph of the same particle of solution. A linear array of monochromatic light sources and sensor photocells are aligned parallel with a polished quartz capillary tube. Signals from each of the photocells, as the same particle of fluid passes through the associated light beam, are summed or statistically correlated. Because the same particle of solution is being tested, the pertinent information in the signal is the same for each reading. The noise should not be correlated to this method of taking multiple readings. The resulting sum (or average, or statistical correlation) has an improved signal to noise ratio because the signal is strengthened by a factor of N (where N is the number of photocell sensors), while the noise is only strengthened by a factor of \sqrt{N} (assuming white noise).

Of course, there is a delay between each signal recorded by separate sensors for a particular fluid particle. To sum or statistically correlate these separate signals, those delays must be taken into account. The summing can be done electronically, with linear delay circuitry, or computer-digitally, by storing signals associated with a particular fluid particle for each sensor.

The novel features which are believed to be characteristic of this invention, both as to its organization and method of operation together with further objectives and advantages thereto, will be better understood from the following description considered in connection with the accompanying drawings in which a presently preferred embodiment of the invention is illustrated by way of example. It is to be expressly understood however, that the drawings are for the purpose of illustration and description only and not intended as a definition of the limits of the invention.

### BRIEF DESCRIPTION OF THE DRAWINGS

FIG. 1 shows a light source, capillary tube and photocell sensors.

FIG. 2 depicts a first electronic method to carry out the invention.

FIG. 3 depicts a second electronic method to carry out the invention.

FIG. 4 represents a first digital method to carry out the invention.

FIG. 5 represents a second digital method to carry out the invention.

FIG. 6 shows a representative clean signal produced by a photocell sensor.

FIG. 7 shows a representative noisy signal produced by a photocell sensor.

FIG. 8 shows an averaged signal produced using the method of the present invention.

FIG. 9 shows a setup for determining the speed of flow of solution.

FIG. 10 shows details of a clock.

FIG. 11 shows a set of baseline compensation photocells.

### BEST MODE FOR CARRYING OUT THE INVENTION

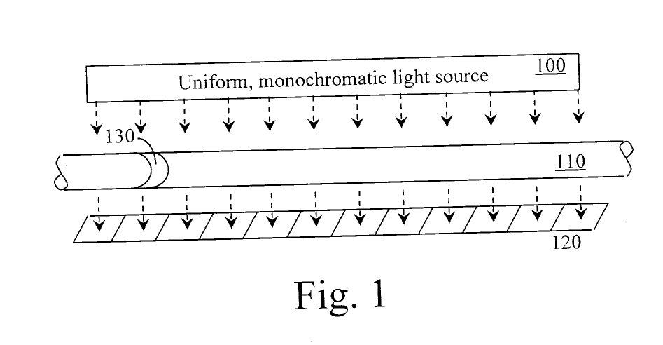

In FIG. 1 is depicted a schematic of the present invention. A uniform, monochromatic light source (or sources) 100 lines one side of a polished quartz capillary tube 110. Directly opposite (on the other side of the capillary tube 110) is a row of photocell sensors 120. Some of the light emitted from the light source 100 is reflected off the capillary tube 110 and the solution flowing through the capillary tube. Some of the light is absorbed by the solution. That light not reflected or absorbed, passes through the capillary tube 110 and the solution flowing in the capillary tube. Each of the photocell sensors 120 creates a signal related to the light intensity of the light that impinges on it. An identifying feature of the components of the solution is the amount of light absorbed.

A signal of interest is one over a period of time. A fluid particle is defined as a small mass of fluid of fixed identity. As a fluid particle of the solution 130 passes within view of a photocell, a signal is recorded based on the light passing through the fluid particle 130 and impinging on the photocell sensor. The same particle of fluid 130 travels past each of the photocell sensors 120 in turn. The velocity of the fluid particle is constant as long as the flow rate of the solution is constant. Due to the small diameter of the capillary tube, the Reynolds number:

$${R}_{e} = \frac{ρ Vd}{μ}$$

(where ρ is the fluid density, V is the fluid velocity, d is the capillary tube diameter, and μ is the fluid's dynamic viscosity) is small. For small Reynolds numbers, flow is laminar. Laminar pipe flow is referred to as Poiseuille flow. In Poiscuille flow, the centerline (maximum) velocity is twice the average velocity, \overline{V}, calculated as:

$$\overline{V} = \frac{4 \dot{m}}{ρ π {d}^{2}}$$

where m is the mass flow rate of the fluid. The fluid particle is assumed to be traveling at the centerline velocity.

Due to the finite speed of flow of the solution, and the finite distance between photocell sensors 120, there is a time delay between the signals emitted from the successive photocell sensors 120. This delay is calculated as:

$${τ}_{d} = \frac{l}{V} = \frac{l}{2 \overline{V}}$$

where τ_{d} is the delay, l is the distance between sensor centerlines, and V is the velocity of the fluid particle 130. This assures that the resulting signal will be a sum of like signals.

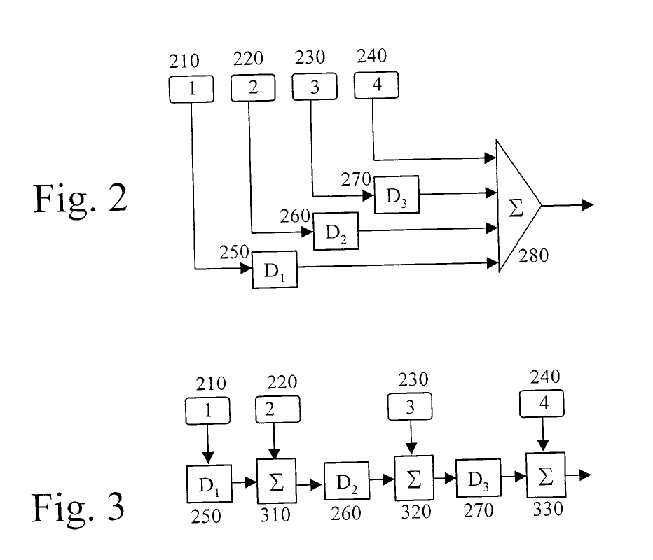

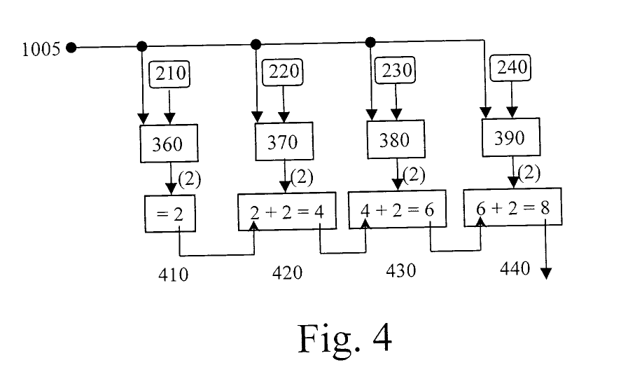

FIG. 2 and FIG. 3 depict arrangements to carry out the present invention electronically. Each photocell sensor 210-240 integrates the light intensity to a charge which produces a signal based on the intensity of the light hitting it. The invention is not limited to only four photocell sensors, and in fact, the preferred embodiment would call for many more (100-1000 typically), and the invention can easily be extended to any number.

As mentioned, a time delay occurs between the signal from one photocell to the next. In FIG. 2, the appropriate delays are provided by delay circuits D₁-D₃ 250-270. Because the delays are effected before the summation (in summation or statistical correlation block 280), the actual delay times vary. The first delay, D₁ 250, is the longest, being equal to (N−1)τ_{d} where N is the number of sensors in the array and τ_{d} is the constant time it takes for the fluid particle to travel from a first photocell sensor to the next photocell sensor immediately adjacent to the first. Delay circuit D₂ 260 provides a delay that is τ_{d} less than that of D₁ 250. Delay circuit D₃ provides for a delay that is τ_{d} less than that of D₂ 260, and being the last delay, is equal to τ_{d}. The signal from photocell sensor 4 240 is passed to the summation or correlation block 280 without a delay. All signals, after applying their respective delays, are summed or correlated in summation or correlation block 280. The resulting, summed (ensemble average times the number of sensors) or statistically correlated signal may be operated on by signal processing hardware to further filter the noise from the signal.

FIG. 3 shows a different arrangement for effecting the instant invention. In this embodiment, all the delay circuits 250-270 for each of the photocells 210-240 execute the same delay, τ_{d}. Successive signals are summed in separate summation (or statistical correlation) blocks 310-330. When the last summation or correlation 330 has been executed, the ensemble average (times the number of sensors) is complete. Again, this invention is not limited to only four photocell sensors.

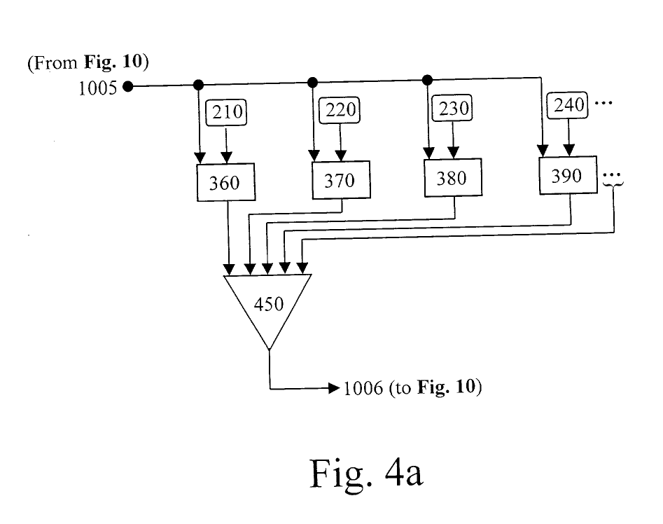

In FIGS. 4 and 4a, digital embodiments of the invention are depicted. Here, the signals are produced at least piecewise continuously (except that photocells maybe blanked during their individual restarts), but stored digitally. The same four photocell sensors 210-240 are shown, but these embodiments are not limited to any particular number of sensors. Each sensor is connected to a corresponding A/D converter 360-390. Each converter produces a series of inherently integrated serial digital signals or words similar to those outputs from commercial scanning photocells for “CD” stereo or ROM discs. Now referring to FIG. 4, these digital signals are stored in discrete memory locations 410-440. As a new signal period is stored, the signals from the previous signal periods are shifted (added to the right in FIG. 4) in memories 410-440.

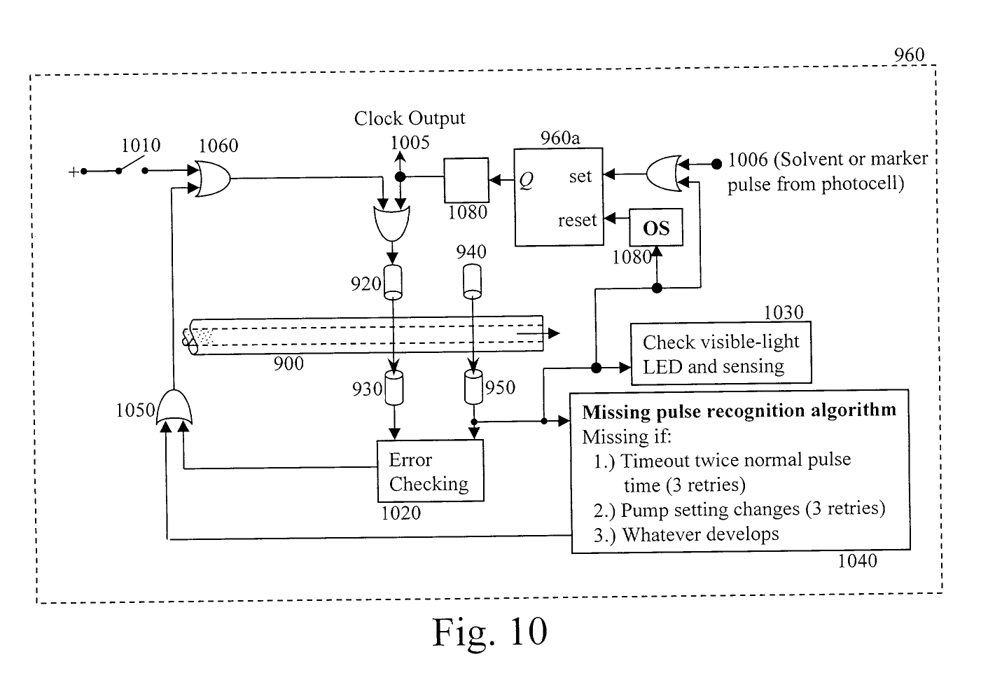

To sum like signals, a delay is calculated based on when each signal period was stored. The signal period representing the signal for the fluid particle of interest for each photocell sensor 210-240 is selected and all the selected periods summed. The example shown in FIG. 4 functions as follows: Upon the arrival of the clock pulse 1005 (from FIG. 10), all outputs from memories 410 to 440 are disconnected. The clock pulse 1005 also allows signals from photocell circuits 210 thru 240 to be entered as serially encoded, internally averaged words, and the photocells are reset to zero equivalent light energy. Then the clock pulse 1005 is released which causes each memory to add (not carry or count) to the following rightwards memory.

FIG. 4 shows a simplified array with only four memory signal processing blocks each receiving data from one photocell. Shown are two (2) signal units from each photocell, being added to each memory block 410-440. Memory block 440 contains eight digital (2+2+2+2) signal units when pulse 1005 is removed. This explanatory circuit is repeated many times. Note the value of only eight in the final memory (440). The memory of 440 contains a section of the reduced noise output in the signal (8). This may be conventionally used as a “chart recorder” output, or with additional memory, as a “CRT screen” output.

The resulting digital signal can be operated on by various additional signal processing methods to further improve the signal to noise ratio. For example matching Gaussian analog or digital domain filters are orthogonal and beneficial additions, as chromatographic signals may be closely approximated as a series of Gaussians.

Refer now to FIG. 4a. The clock pulse timing can be determined by electronically monitoring the passage of the solvent spike at the start of chromatogram, or other marker in the chromatogram, as the spike or marker transits from one photocell to the next (210→220→230→240→and following). The spike or marker is digitally strobed by the A/D converters 360→370→380→390→and following. A multiple input peak detector 450 detects the presence of a solvent spike or marker on the next photocell after the start, or after detection from the previous photocell. This causes the initiation (line 1006) of a clock pulse (FIG. 10).

Four or more parallel signals are input to the peak detector 450. Each input is 16-bit serial. The peak detector 450 detects peaks only from highest numbered photocell, and only if the peak exceeds a threshold.

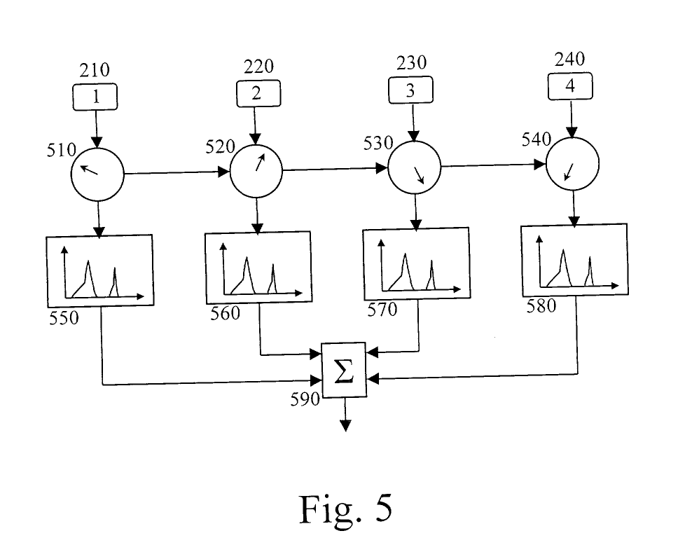

It can be seen that grouped signals can be added or correlated by this invention, as depicted in FIG. 5. Here, clocks 510-540 determine when grouped signals are to be stored in the memory locations 550-580. The clocks provide delays to ensure that each of these signals is for the same particle of fluid. The signals are all summed in the summation block 590. The photocell signals are all the same with respect to a point on the chromatogram.

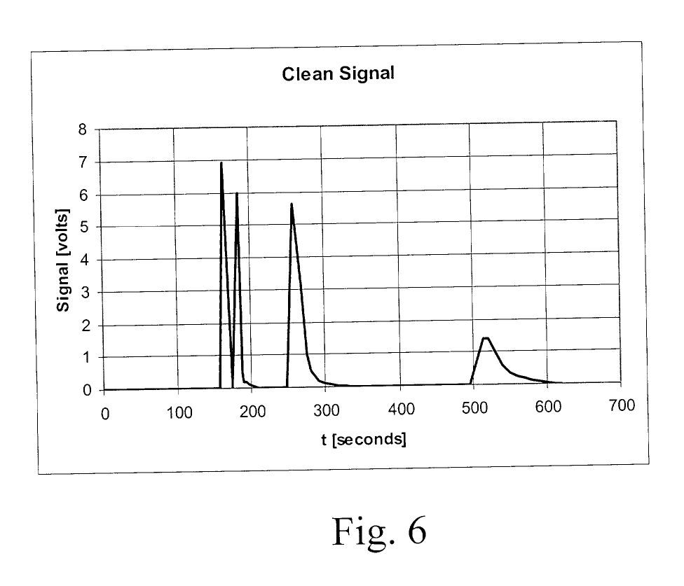

In FIG. 6, a sample of a clean HPLC (noiseless) signal is shown with four peaks. The abscissa is time in seconds, while the ordinate is the signal, as amplified from a photovoltaic sensor, in volts.

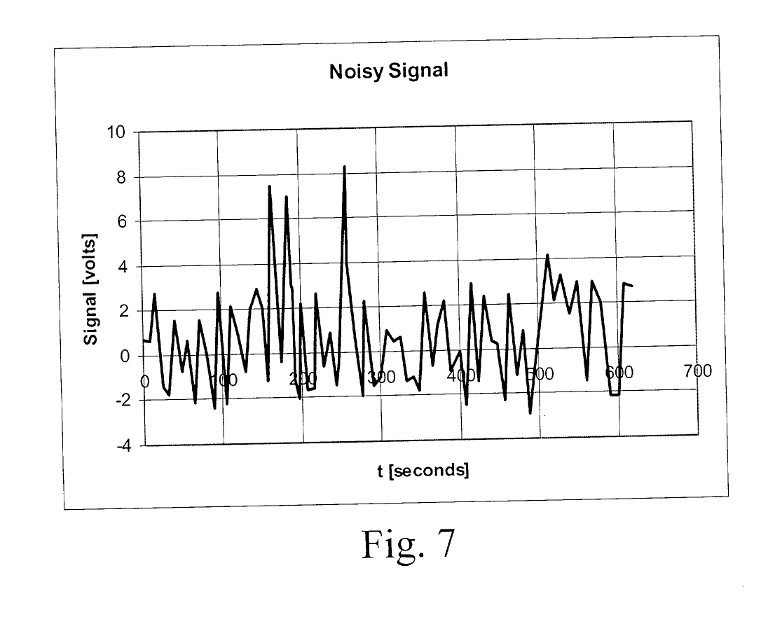

The same signal as shown in FIG. 6 is replotted in FIG. 7 with simulated noise superimposed on the clean signal. The white noise has a maximum amplitude of three volts. The clean signal cannot be identified due to the noise.

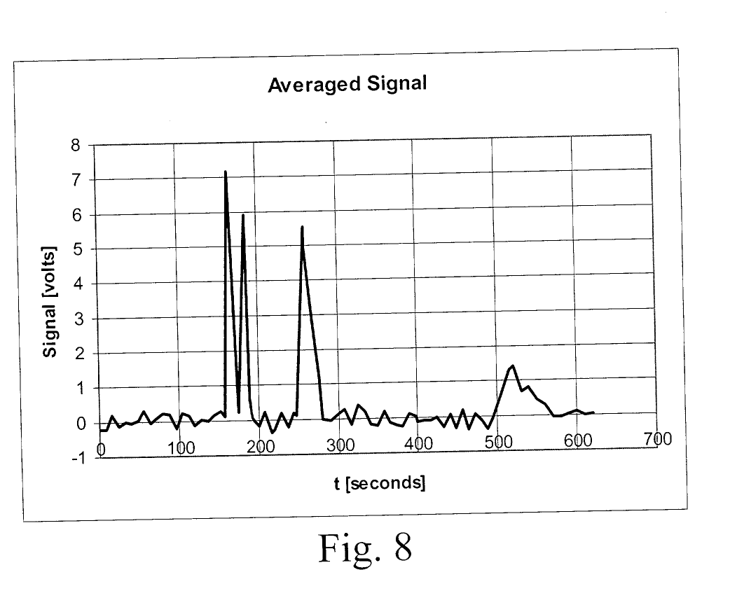

The next step in the analysis is shown in FIG. 8. Here, 100 noisy signals, with the same clean content as shown in FIG. 6 and different noise (all with a maximum amplitude of three volts), were averaged. The improvement can easily be seen when comparing FIG. 8 with FIG. 7. The improvement is evident, even though only 100 “sensors” were used (in practice, many more could be used). Even the last and smallest peak (seen in FIG. 6 at about 515 seconds) can be resolved from the noise.

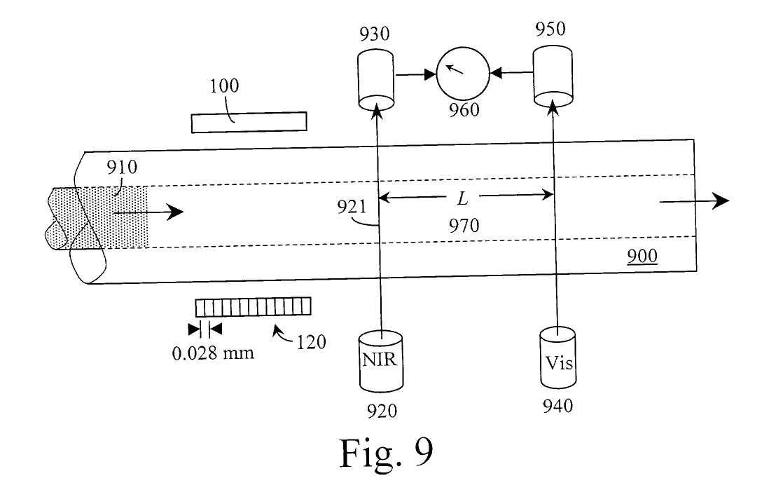

Another method for determining the speed of the flow of the solution is shown in FIGS. 9 and 10. Refer first to FIG. 9. It shows the production of one clock pulse for the transit of one particle of fluid moving from one photocell (e.g. 220) to the next. A capillary chromatography column 900 is shown. The fluid first flows through the column packing 910, where complete thermal mixing occurs. The monochromatic light source(s) 100 and set of photocell sensors 120 are shown. Refer now to FIG. 9. The energetic NIR light source 920 consists of a 60 watt Xenon lamp with conventional optics not shown. Near infrared (NIR) wavelength is preferred to visible as it is absorbed by most chromatographic solvents.

Each NIR pulse from 920 heats a particle of fluid along its beam 921 through the bore of capillary tube 900. The higher-temperature fluid exhibits different optical properties, importantly its refractive index, compared to the surrounding fluid. By passing light from a visible-light source 940 to a visible-light photocell 950, it is possible to detect the heated particle of fluid. A clock or phase-measuring device 960 is used to determine the time required for the particle to travel from the point at which it is heated to the location at which its presence is detected by the visible light. The distance, L 970, between these two points must also be known and may be equal to the spacing between adjacent photocells (FIG. 1). Dividing the time from the clock 960 into the distance, L 970, results in the speed of the flow of solution. Therefore, the duration of each such derived clock pulse is calculated as the time it takes a particle to traverse the distance from one photocell to the next (FIG. 1). This synchronization is important as fluid speed along length, L 970, related to the propagation speed along the capillary detector.

Details of the clock 960 are shown in FIG. 10. It is embodied as a set/reset flip-flop whose frequency is set by timing from the photocell 950. It may be convenient to utilize a distance L 970 considerably greater than the distance between absorbance sensing photocells (FIG. 1). Possible reasons would be to prevent crosstalk between the beams or to extend Xenon flash lamp life. This means that a number of sensor photocells must be sequentially clocked for absorbance measurement between each pair of flashes of the Xenon flash lamp. In this case it is necessary to generate evenly spaced clock pulses corresponding to detection by the photocell 950 and a resulting pair of lamp flashes. This is accomplished by a multiple pulse generator 1080, that produces pulses at the rate of (photocell 950 events)×(spacing L 970)÷(spacing between absorbance measuring photocells). This can be realized by a conventional phase locked loop frequency multiplier or a computer software interpolator that produces multiple pulses interpolated between signals from photocell 950. A reset switch 1010 can be closed either manually or automatically after the pump setting is changed.

The pulsed NIR pulsed light source 920 is shown with its NIR photocell 930. The visible-light source 940 and the visible-light photocell 950 are also shown. Focusing optics are recommended for the sources 920, 940 and the photocells 930-950 but are not shown in the figure. The signals produced by the NIR photocell 930 and the visible-light photocell 950 are checked for errors in the error checking routine 1020. The visible-light source 940 and photocell 950 are checked to assure their proper operation in block 1030. A three-step lost-pulse recognition scheme 1040 is also applied to the visible-light photocell signal. A pulse is considered missing if:

1. Timeout twice normal pulse time (3 retries).

2. Pump setting changes (3 retries).

3. Whatever develops.

Number 3 provides flexibility as experience teaches what may cause missed pulses.

The results of the error checking routine 1020 and the missing pulse recognition algorithm 1040 pass into a first AND block 1050. The result of the first AND block 1050 and the signal from the switch 1010 enter a second AND block 1060, the result of which is used to control the clock function 1000.

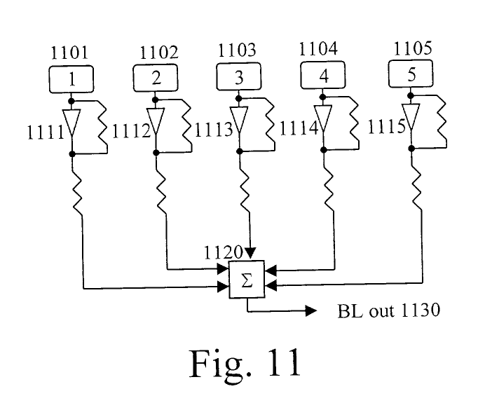

Five dual beam baseline compensation photocells 1101-1105 are depicted in FIG. 11. Each photocell has a preamp 1111-1115. The signals from all the preamps 1111-1115 are summed in summation block 1120, resulting in the baseline (BL) signal 1130.

In any of the given embodiments, either a summation or an average of the noisy signal can be used to analyze the makeup of the liquid; where the average signal can be calculated simply by dividing the sum by the number, N, of photocell sensors being used.

Obviously many modifications and variations of the present invention are possible in light of the above teachings. It is, therefore, to be understood that within the scope of the appended claims, the invention may be practiced otherwise than as specifically described.

I claim:

1. A method for improving a quality of a signal in High Performance Liquid Chromatography by employing a plurality of stationary sensors, the method comprising:
(a) sensing information about a same fluid particle with each of the plurality of sensors and producing a plurality of individual signals, one for each stationary sensor, based on said information; and
(b) summing said plurality of signals to create a signal with greater signal to noise ratio than any of the individual plurality of signals.

2. A method for improving a quality of a signal in High Performance Liquid Chromatography by employing a plurality of stationary sensors, the method comprising:
(a) sensing information about a same fluid particle with each of the plurality of sensors and producing a plurality of individual signals, one for each stationary sensor, based on said information; and
(b) statistically correlating said plurality of signals to create a signal with greater signal to noise ratio than any of the individual plurality of signals.

3. The method of claim 1 wherein a delay is incorporated into said individual signals to account for different times at which the signals are produced.

4. The method of claim 2 wherein a delay is incorporated into said individual signals to account for different times at which the signals are produced.

5. The method of claim 3 wherein the delay is calculated as a function of a speed of a fluid flow and a distance between sensor center points.

6. The method of claim 4 wherein the delay is calculated as a function of a speed of a fluid flow and a distance between sensor center points.

7. The method of claim 5 wherein the delay is calculated as a ratio of a distance between sensor center points and twice an average speed of the fluid flow.

8. The method of claim 6 wherein the delay is calculated as a ratio of a distance between sensor center points and twice an average speed of the fluid flow.

9. The method of claim 5 wherein the delay is applied to a first signal from a first sensor before summing the first signal with a second signal from a second sensor spatially immediately adjacent to the first sensor.

10. The method of claim 6 wherein the delay is applied to a first signal from a first sensor before correlating the first signal with a second signal from a second sensor spatially immediately adjacent to the first sensor.

11. The method of claim 5 wherein the plurality of sensors number N with a most upstream sensor numbered N, a next sensor immediately downstream numbered N−1, while the last sensor is numbered 1; the n^{th} delay applied to the signal generated by an n^{th} sensor being calculated as n−1 times the delay calculated as the function of the average speed of the fluid flow; a single summation being used for all signals after applying the associated delays.

12. The method of claim 6 wherein the plurality of sensors number N with a most upstream sensor numbered N, a next sensor immediately downstream numbered N−1, while the last sensor is numbered 1; the n^{th} delay applied to the signal generated by an n^{th} sensor being calculated as n−1 times the delay calculated as the function of the average speed of the fluid flow; a single correlation being used for all signals after applying the associated delays.

13. The method of claim 1 wherein the summation is subsequently divided by a number of the plurality of sensors to produce an average.

14. The method of claim 1 wherein signals are produced at least piecewise continuously by each sensor and stored, digitally.

15. The method of claim 2 wherein signals are produced at least piecewise continuously by each sensor and stored, digitally.

16. The method of claim 14 wherein portions of the at least piecewise continuous signals containing information about the same fluid particle are selected for summation.

17. The method of claim 15 wherein portions of the at least piecewise continuous signals containing information about the same fluid particle are selected for correlation.

18. The method of claim 1 including timers for each sensor, the timers dictating when the sensors' signals will be stored for the same fluid particle.

19. The method of claim 2 including timers for each sensor, the timers dictating when the sensors' signals will be stored for the same fluid particle.

20. The method of claim 5 wherein the speed of the flow of fluid is determined by the steps comprising:
(a) heating a particle of fluid with a pulsed light signal at a known point in the flow;
(b) determining when the particle of fluid passes a downstream point having a known distance from the known point at which it was heated by detecting a difference in its refractive index;
(c) measuring the time between heating the fluid particle to its detection at the downstream point; and
(d) dividing the known distance between the point at which the fluid particle was heated to the downstream point by the measured time between heating the fluid particle to its detection at the downstream point.

21. The method of claim 6 wherein the speed of the flow of fluid is determined by the steps comprising:
(a) heating a particle of fluid with a pulsed light signal at a known point in the flow;
(b) determining when the particle of fluid passes a downstream point having a known distance from the known point at which it was heated by detecting a difference in its refractive index;
(c) measuring the time between heating the fluid particle to its detection at the downstream point; and
(d) dividing the known distance between the point at which the fluid particle was heated to the downstream point by the measured time between heating the fluid particle to its detection at the downstream point.

22. The method of claim 20 wherein detecting a difference in its refractive index is carried out using a visible-light source and a visible-light sensor.

23. The method of claim 21 wherein detecting a difference in its refractive index is carried out using a visible-light source and a visible-light sensor.

24. An apparatus for improving a quality of a signal in High Performance Liquid Chromatography, the apparatus comprising a plurality of stationary sensors, and:
(a) means for sensing information about a same fluid particle with each of the plurality of sensors with means for producing a plurality of individual signals, one for each stationary sensor, based on said information; and
(b) means for summing said plurality of signals to create a signal with greater signal to noise ratio than any of the individual plurality of signals.

25. An apparatus for improving a quality of a signal in High Performance Liquid Chromatography, the apparatus comprising a plurality of stationary sensors, and:
(a) means for sensing information about a same fluid particle with each of the plurality of sensors with means for producing a plurality of individual signals, one for each stationary sensor, based on said information; and
(b) means for statistically correlating said plurality of signals to create a signal with greater signal to noise ratio than any of the individual plurality of signals.

26. The apparatus of claim 24 including means to incorporate a delay into said individual signals to account for different times at which the signals are produced.

27. The apparatus of claims 25 including means to incorporate a delay into said individual signals to account for different times at which the signals are produced.

28. The apparatus of claim 26 including means to calculate the delay as a function of a speed of a fluid flow and a distance between sensor center points.

29. The apparatus of claim 27 including means to calculate the delay as a function of a speed of a fluid flow and a distance between sensor center points.

30. The apparatus of claim 28 including means to calculate the delay as a ratio of a distance between sensor center points and twice an average speed of the fluid flow.

31. The apparatus of claim 29 including means to calculate the delay as a ratio of a distance between sensor center points and twice an average speed of the fluid flow.

32. The apparatus of claim 28 including means to apply the delay to a first signal from a first sensor before summing the first signal with a second signal from a second sensor spatially immediately adjacent to the first sensor.

33. The apparatus of claim 29 including means to apply the delay to a first signal from a first sensor before correlating the first signal with a second signal from a second sensor spatially immediately adjacent to the first sensor.

34. The apparatus of claim 28 wherein the plurality of sensors number N with a most upstream sensor numbered N, a next sensor immediately downstream numbered N−1, while the last sensor is numbered 1; the apparatus including means to calculate the n^{th} delay applied to the signal generated by an n^{th} sensor as n−1 times the delay calculated as the function of the average speed of the fluid flow; and means to sum all signals in a single summation after applying the associated delays.

35. The apparatus of claim 29 wherein the plurality of sensors number N with a most upstream sensor numbered N, a next sensor immediately downstream numbered N−1, while the last sensor is numbered 1; the apparatus including means to calculate the n^{th} delay applied to the signal generated by an n^{th} sensor as n−1 times the delay calculated as the function of the average speed of the fluid flow; and means to correlate all signals in a single correlation after applying the associated delays.

36. The apparatus of claim 24 including means for subsequently dividing the summation by a number of the plurality of sensors to produce an average.

37. The apparatus of claim 24 including means for continuously producing signals by each sensor and means for digitally storing said continuous signals.

38. The apparatus of claim 25 including means for continuously producing signals by each sensor and means for digitally storing said continuous signals.

39. The apparatus of claim 37 including means to select portions of the continuous signals containing information about the same fluid particle for summation.

40. The apparatus of claim 38 including means to select portions of the continuous signals containing information about the same fluid particle for statistical correlation.

41. The apparatus of claim 24 including timers for each sensor, the timers dictating when the sensors' signals will be stored for the same fluid particle.

42. The apparatus of claim 25 including timers for each sensor, the timers dictating when the sensors' signals will be stored for the same fluid particle.

43. The apparatus of claim 28 including fluid flow speed determination means comprising:
(a) a pulsed near infrared light source for heating a particle of fluid at a known point in the flow;
(b) a sensor to determine when the particle of fluid passes a downstream point having a known distance from the known point at which it was heated by detecting a difference in its refractive index;
(c) a timer for measuring the time between heating the fluid particle to its detection at the downstream point; and
(d) means for dividing the known distance between the point at which the fluid particle was heated to the downstream point by the measured time between heating the fluid particle to its detection at the downstream point.

44. The apparatus of claim 29 including fluid flow speed determination means comprising:
(a) a pulsed near infrared light source for heating a particle of fluid at a known point in the flow;
(b) a sensor to determine when the particle of fluid passes a downstream point having a known distance from the known point at which it was heated by detecting a difference in its refractive index;
(c) a timer for measuring the time between heating the fluid particle to its detection at the downstream point; and
(d) means for dividing the known distance between the point at which the fluid particle was heated to the downstream point by the measured time between heating the fluid particle to its detection at the downstream point.

45. The method of claim 5 additionally comprising the steps of:
(a) continuously monitoring at least two of said plurality of sensors;
(b) measuring the time taken for the detection of a chromatographic solvent spike or a marker as it transits between the said sensors; and using the said time to establish the said delay.

46. The method of claim 6 additionally comprising the steps of:
(a) continuously monitoring at least two of said plurality of sensors;
(b) measuring the time taken for the detection of a chromatographic solvent spike or a marker as it transits between the said sensors; and using the said time to establish the said delay.

47. The apparatus of claim 24 additionally comprising a timer for measuring the time taken for the detection of a chromatographic solvent spike or a marker as it transits between at least two of said plurality of sensors; and using the said time to establish the said delay.

48. The apparatus of claim 25 additionally comprising a timer for measuring the time taken for the detection of a chromatographic solvent spike or a marker as it transits between at least two of said plurality of sensors; and using the said time to establish the said delay.

49. The apparatus of claim 43 including a visible-light source and a visible-light sensor for detecting a difference in the refractive index.

50. The apparatus of claim 44 including a visible-light source and a visible-light sensor for detecting a difference in the refractive index.
